(19) United States
(12) Patent Application Publication
(10) Pub. No.: US 2026/0100891 A1
(43) Pub. Date: Apr. 9, 2026

(54) SYSTEM AND METHOD FOR AI/ML MEASUREMENT REPORTING AND HANDOVER TRIGGERING

(71) Applicant: Samsung Electronics Co., Ltd., Gyeonggi-do (KR)

(72) Inventors: Abbas KHALILI OLAM, San Diego, CA (US); Jung Hyun BAE, San Diego, CA (US)

(21) Appl. No.: 19/349,580

(22) Filed: Oct. 3, 2025

Related U.S. Application Data
(60) Provisional application No. 63/703,586, filed on Oct. 4, 2024.
(60) Provisional application No. 63/703,623, filed on Oct. 4, 2024.

(51) Int. Cl. H04L 41/16; H04B 17/318; H04W 36/00

(52) U.S. Cl. CPC H04L 41/16; H04B 17/328; H04W 36/0058

(57) ABSTRACT

A method performed by a user equipment (UE) in a wireless communication system is provided. The method includes obtaining a measurement associated with a serving cell and one or more candidate cells; generating input data based on the measurement; applying an artificial intelligence or machine learning (AI/ML) model to the input data using a prediction time advance (T) to determine whether to transmit a measurement report or initiate a handover from the serving cell to a target cell; and in accordance with the determination, performing at least one of transmitting the measurement report or initiating the handover.

### CROSS-REFERENCE TO RELATED APPLICATIONS

This application claims the priority benefit under 35 U.S.C. § 119(e) of U.S. Provisional Application No. 63/703,586, filed on Oct. 4, 2024, and U.S. Provisional Application No. 63/703,623, filed on Oct. 4, 2024, the disclosures of which are incorporated by reference in their entireties as if fully set forth herein.

### TECHNICAL FIELD

The disclosure generally relates to wireless communication systems. More particularly, the subject matter disclosed herein relates to improvements to handover decision making, measurement reporting, and handover triggering through artificial intelligence and machine learning (AI/ML)-based techniques.

### SUMMARY

Wireless networks may rely on mobility management to maintain reliable connectivity as user equipment (UE) moves between cells. However, mobility procedures such as event-triggered reporting and handover execution may be often prone to performance issues in dense or dynamic deployments. In particular, static time-to-trigger (TTT) values and threshold-based reporting conditions can lead to outcomes such as frequent handovers (e.g., ping-pong events), too-late handovers resulting in radio link failure (RLF), or handover failures caused by poorly timed execution.

To solve these problems, systems may have relied on network-centric control in which the serving cell configures reporting conditions and determines when a handover should be executed. Event-triggered reporting and conditional handover have been developed to reduce unnecessary handovers and improve robustness.

One issue with the above approaches may be that they depend heavily on fixed parameters and network-wide assumptions, which may not reflect the mobility conditions experienced by an individual UE. As a result, the handover process may remain untimely or inefficient, leading to service interruptions, increased signaling overhead, and degraded user experience.

To overcome these issues, systems and methods are described herein for enabling a UE to apply an AI/ML model to measurement data to determine whether to transmit a measurement report or initiate a handover, based on a prediction time advance. In some embodiments, training data for the AI/ML model may be generated by segmenting measurement logs into windows of K measurement instances and associating them with mobility outcomes such as successful connections, frequent handovers, or RLFs. These outcomes may be mapped into outcome label classes (e.g., perform handover, not perform handover, send measurement report, or not send measurement report) that are used to supervise model training. The AI/ML model may be implemented using, for example, gradient boosting or neural network architectures.

The above approaches improve on previous methods because the UE may become capable of making user-centric mobility decisions that are adaptive to real conditions while still permitting the network to override or confirm the UE's predicted actions. As a result, measurement reporting and handover initiation can be performed with improved accuracy and timeliness, reducing unnecessary handovers, lowering the risk of RLF, and improving overall reliability and efficiency of mobility management in wireless networks.

In an embodiment, a method performed by a UE includes obtaining a measurement associated with a serving cell and one or more candidate cells; generating input data based on the measurement; applying an AI/ML model to the input data using a prediction time advance (T) to determine whether to transmit a measurement report or initiate a handover from the serving cell to a target cell; and in accordance with the determination, performing at least one of transmitting the measurement report or initiating the handover.

In another embodiment, a UE includes a processor and a memory storing instructions which, when executed by the processor, cause the UE to obtain a measurement associated with a serving cell and one or more candidate cells; generate input data based on the measurement; apply an AI/ML model to the input data using a prediction time advance (T) to determine whether to transmit a measurement report or initiate a handover from the serving cell to a target cell; and in accordance with the determination, perform at least one of transmitting the measurement report or initiating the handover.

In another embodiment, a non-transitory computer-readable medium is provided that stores instructions which, when executed by one or more processors of a UE, cause the UE to obtain a measurement associated with a serving cell and one or more candidate cells; generate input data based on the measurement; apply an AI/ML model to the input data using a prediction time advance (T) to determine whether to transmit a measurement report or initiate a handover from the serving cell to a target cell; and in accordance with the determination, perform at least one of transmitting the measurement report or initiating the handover.

### BRIEF DESCRIPTION OF THE DRAWING

In the following section, the aspects of the subject matter disclosed herein will be described with reference to exemplary embodiments illustrated in the figures, in which:

FIG. 1 is a block diagram illustrating a transmitting device or a receiving device in a communication system, according to an embodiment;

FIG. 2 is a signaling diagram illustrating a handover procedure in a new radio (NR) communication system, according to an embodiment;

FIG. 3 is a signaling diagram illustrating a conditional handover procedure, according to an embodiment;

FIG. 4 illustrates examples of mobility problems that may occur when a handover is not appropriately controlled, according to an embodiment;

FIG. 5 illustrates examples of mobility problems that may occur when a handover is not appropriately controlled, according to an embodiment;

FIG. 6A is a block diagram illustrating an AI/ML-based framework for measurement reporting and handover triggering, according to an embodiment;

FIG. 6B is a signaling diagram illustrating initiating an AI/ML-based measurement report and handover initiation, according to an embodiment;

FIG. 7 is a signaling diagram illustrating a handover procedure, according to an embodiment;

FIG. 8 is a schematic diagram illustrating a gradient boosting classifier for mobility prediction, according to an embodiment;

FIG. 9 is a schematic diagram illustrating a deep neural network model, according to an embodiment;

FIG. 10 is a flowchart illustrating a method performed by a UE for AI/ML-based measurement report transmission and/or handover initiation, according to an embodiment;

FIG. 11 is a block diagram of an electronic device in a network environment, according to an embodiment; and

FIG. 12 is a system including a UE and a next generation NodeB (gNB), in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

The present disclosure relates to a method that allows a phone or device to communicate more effectively with a cell tower, especially when dealing with multiple signals or channels. The device can receive instructions on how to report the condition of multiple signal paths, decide the best way to do this, and then send this information back to the network. If there are too many signals to report at once, the device can figure out which ones are most important and just report those. This method helps the network understand and adapt to how signals are being received by the device, which can improve call quality and data speed.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Serving cell” as used herein refers to a serving cell to which a UE is currently connected and from which it obtains downlink signals and transmits uplink signals. Some examples of a “serving cell” are a primary cell in a fifth generation (5G) NR network or a serving cell in long term evolution (LTE)/NR dual connectivity.

“Target cell” as used herein refers to a cell to which a UE may perform a handover from the serving cell. Some examples of a “target cell” are a neighboring cell that satisfies a measurement event condition or a candidate cell selected by an AI/ML model for improved mobility performance.

“Candidate cell” as used herein refers to any cell, other than the current serving cell, that may potentially serve as a target cell for handover. A candidate cell becomes a target cell once selected by the UE or the network for handover execution. Some examples of “candidate cells” include neighboring cells measured by the UE and reported in a measurement report.

“Prediction time advance (T)” as used herein refers to a configurable time parameter that defines an interval between when an action such as transmitting a measurement report or initiating a handover is predicted to occur and when that action is actually executed. Some examples of a “prediction time advance T” include values expressed in milliseconds (ms) that allow the UE to coordinate measurement report transmission or handover initiation in advance of actual mobility events.

“Measurement report” or “MeasRep” as used herein refers to a signaling message transmitted by a UE to a network node, such as a gNB, containing one or more measurement values associated with a serving cell and one or more candidate cells. Some examples of a “measurement report” or “MeasRep” include reports containing reference signal received power (RSRP), reference signal received quality (RSRQ), and/or signal-to-interference-plus-noise ratio (SINR).

“Measurement log” as used herein refers to a record of sequentially obtained measurements of one or more cells over time, typically maintained by a UE or generated from network-side data collection. Some examples of a “measurement log” include time-stamped sequences of RSRP, RSRQ, or SINR values for the serving cell and one or more candidate cells, which may be segmented into windows and used as input to an AI/ML model.

“Radio link failure” or “RLF” as used herein refers to a condition in which a UE is unable to maintain a reliable radio connection with its serving cell. Some examples of “radio link failure” or “RLF” include scenarios where the UE loses synchronization with the serving cell, fails to complete a random access procedure during handover, or triggers a radio recourse control (RRC) re-establishment procedure to recover connectivity.

“Handover” or “HO” as used herein refers to a procedure in which a UE transitions its connection from a serving cell to a target cell, under control of either the UE, the network, or both. Some examples of a “handover” include an intra-frequency handover between two gNBs (e.g., serving cell and target cell) in the same frequency band or an inter-frequency handover where the UE switches between different bands.

“User equipment” or “UE” as used herein refers to any wireless terminal configured to connect to a cellular or wireless network. Some examples of “user equipment” include a smartphone, a tablet, a laptop computer with cellular connectivity, or a device that supports LTE or NR access.

“Next generation NodeB” or “gNB” as used herein refers to a base station that provides 5G NR wireless access to one or more UEs. Some examples of a “gNB” include a base station serving a wide geographic area or a small cell base station deployed in dense urban environments.

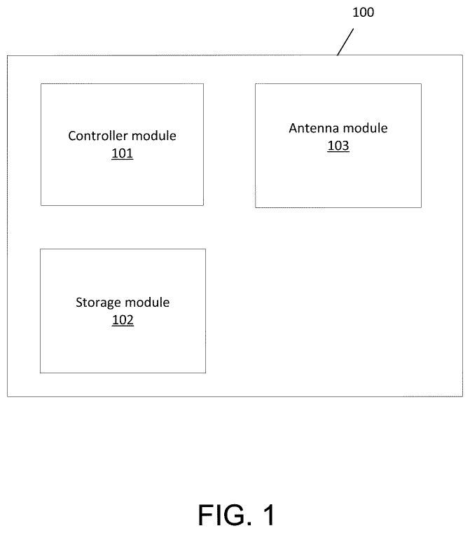

FIG. 1 is a block diagram illustrating a transmitting device or a receiving device in a communication system, according to an embodiment.

Referring to FIG. 1, the device 100 may correspond to a UE or a base station, such as a gNB. The device 100 may include a controller module 101, a storage module 102, and an antenna module 103.

The controller module 101 may include one or more processors configured to execute instructions for performing measurement collection, evaluation of mobility conditions, and execution of AI/ML models. In some embodiments, the controller module 101 may apply the AI/ML model to measurement results associated with serving and candidate cells in order to determine when to transmit a measurement report or when to trigger a handover. The controller module 101 may also process time advance information and other parameters that are used to align the timing of model predictions with handover execution.

The storage module 102 may comprise memory that stores instructions and data associated with the functions of the device 100. The storage module 102 may store measurement logs, event identifiers, and RLF outcomes that can be used for training or retraining of the AI/ML model. In some embodiments, the storage module 102 may also store pre-generated training samples derived from field logs, as well as model parameters associated with supervised or unsupervised learning schemes.

The antenna module 103 may include one or more antennas for transmitting and receiving signals with a base station or UE. The antenna module 103 may enable the device 100 to collect downlink measurements such as RSRP, RSRQ, and/or SINR, which may be provided as input to the AI/ML model. The antenna module 103 may further support uplink signaling for transmission of measurement reports or handover-related control information.

In wireless systems, one of the primary mechanisms used for mobility control is an event-triggered handover. In such procedures, a UE may first be configured by a serving cell with one or more event-triggered reporting configurations. Each configuration may specify conditions under which the UE should generate a measurement report. The UE continually evaluates the configured conditions, and once a condition is satisfied for a prescribed duration known as the TTT, the corresponding event is considered triggered. When the event is triggered, the UE transmits the associated measurement report to the serving network node. Based on the report, the serving cell may then issue a handover command to the UE, instructing it to move to a target cell.

An event may also become un-triggered if its leaving condition is satisfied for the TTT duration. The 3rd Generation Partnership Project (3GPP) defines several possible events that can be used to initiate handovers in NR systems. These events are based on comparisons of layer three (L3) signal measurements, such as RSRP, RSRQ, or SINR, obtained from underlying physical layer measurements. Each event may have defined entering and leaving conditions, which govern when the event becomes active and when it is released. For example, an event may be configured to trigger when the signal strength of a candidate target cell becomes better than that of the serving cell by a specified margin plus hysteresis, and to un-trigger when the relative advantage falls below a threshold.

Through this framework, event-triggered handover provides the network with a structured way to initiate mobility procedures based on real-time signal conditions. However, as described elsewhere in this disclosure, reliance on fixed thresholds and static TTT values may lead to frequent handovers, delayed handovers, or failures.

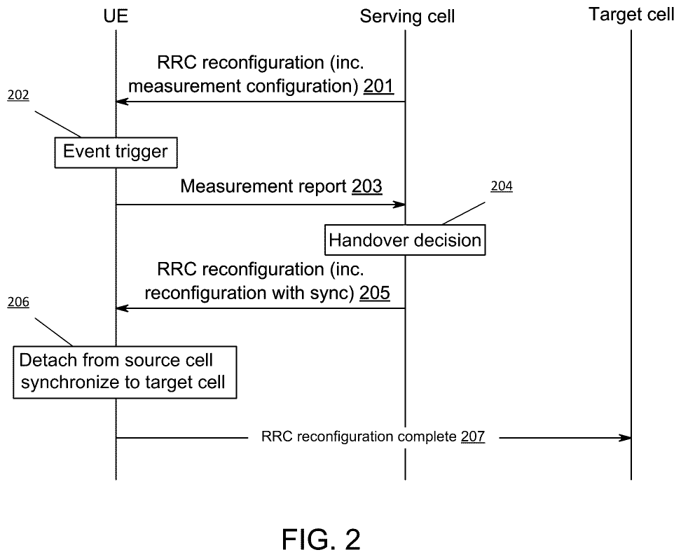

FIG. 2 is a signaling diagram illustrating a handover procedure in an NR communication system, according to an embodiment.

Referring to FIG. 2, a UE may initially communicate with a serving cell. In preparation for a potential handover, the serving cell may configure the UE with one or more measurement configurations in step 201. According to an embodiment, a measurement configuration may include a measurement object that specifies a set of reference signals and a reporting configuration that specifies triggering conditions for measurement reporting. In step 202, the UE evaluates whether one or more triggering conditions are satisfied to determine whether an event is triggered. In step 203, the UE may generate and transmit a measurement report to the serving cell. Upon receiving the measurement report, the serving cell may evaluate whether to initiate a handover in step 204. If the decision is affirmative, the serving cell may issue a handover command identifying a target cell via an RRC configuration in step 205. The UE may detach from the serving cell, synchronize with the target cell in step 206, and complete an RRC reconfiguration procedure in step 207.

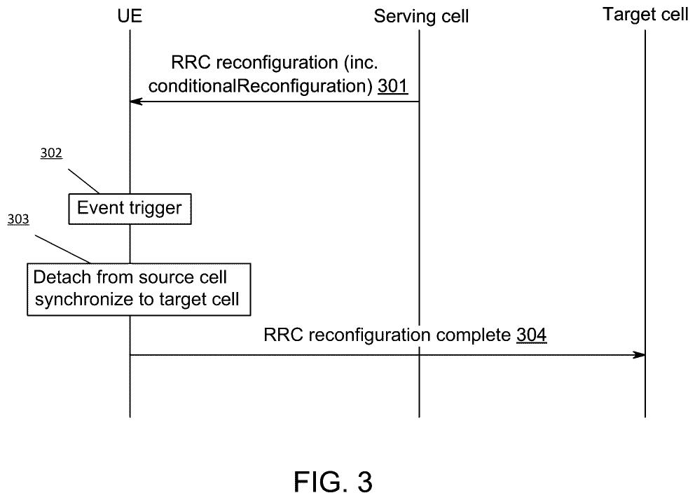

FIG. 3 is a signaling diagram illustrating a conditional handover procedure, according to an embodiment.

Referring to FIG. 3, the serving cell may configure the UE with one or more conditional handover RRC configurations in step 301. According to an embodiment, a configuration may include a measurement object and conditional reconfiguration information identifying one or more candidate target cells. In step 302, the UE may perform measurements of the candidate cells and evaluate the configured conditions to determine whether an event is triggered. If a condition is satisfied, the UE may autonomously initiate handover to the corresponding target cell without waiting for a subsequent handover command in step 303. In this case, the serving cell may provide conditional reconfiguration information in advance, allowing the UE to directly perform RRC reconfiguration with the target cell in step 304. As with the procedure in FIG. 2, the UE detaches from the serving cell, synchronizes with the target cell, and completes RRC reconfiguration.

In both procedures, the serving cell or the network retains primary decision-making responsibility for handover initiation.

While the handover procedures illustrated in FIG. 2 and FIG. 3 enable continuity of service, mobility-related issues may arise. For example, in dense deployments, particularly at millimeter wave (mmWave) frequencies, cell coverage may be small, and a UE may frequently traverse multiple coverage areas. In such cases, a poorly timed or suboptimal handover decision can lead to several types of mobility failures.

One issue may be frequent handover, which occurs when the UE performs repeated handovers in a short period. Frequent handovers may include ping-pong handovers, in which the UE is handed over from a first cell to a second cell and then rapidly returned to the first cell. Frequent handovers may also include extra-cell handovers, in which the UE is unnecessarily handed over to multiple cells in sequence.

Another issue may be too late handover, which occurs when the UE remains connected to the serving cell beyond the point at which the connection quality is sustainable. In this case, the serving cell link may degrade to the extent that an RLF occurs before handover can be completed.

A further issue may be handover failure, which occurs when the UE receives a handover command but fails to complete reconfiguration to the target cell, or connects to an inappropriate candidate cell. A too early handover, in which the target cell does not yet provide sustainable service, and a wrong cell handover, in which the UE attempts to connect to a non-optimal target, may both result in failure.

Accordingly, various embodiments described herein provide systems and methods that incorporate AI/ML to enable user-centric measurement report transmission and handover triggering. By applying an AI/ML model in the UE to measurement data, various procedures may be introduced to reduce the occurrence of one or more of frequent handovers, too late handovers, and/or handover failures.

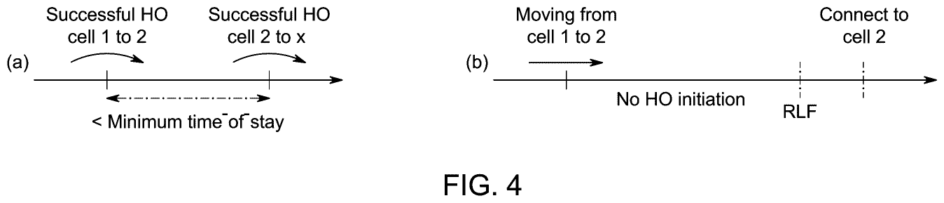

FIG. 4 illustrates examples of mobility problems that may occur when a handover is not appropriately controlled, according to an embodiment.

Referring to (a) in FIG. 4, a UE may first be handed over from a cell 1 to a cell 2 and then quickly handed over again from the cell 2 to another cell x. The elapsed time between these handovers is shown as being less than a minimum time-of-stay requirement. This type of behavior may lead to unnecessary handovers, sometimes referred to as ping-pong handover when the UE returns to a previous cell, or extra-cell handover when the UE is transferred to a different cell.

Referring to (b) of FIG. 4, the UE may move from a cell 1 toward a cell 2. In this case, no handover initiation occurs while the UE is still served by the cell 1. As the signal quality of cell 1 continues to degrade, the UE may experience an RLF. After the failure, the UE may connect to the cell 2. This example may correspond to a too late handover case, where service continuity is interrupted because the handover was not triggered in time.

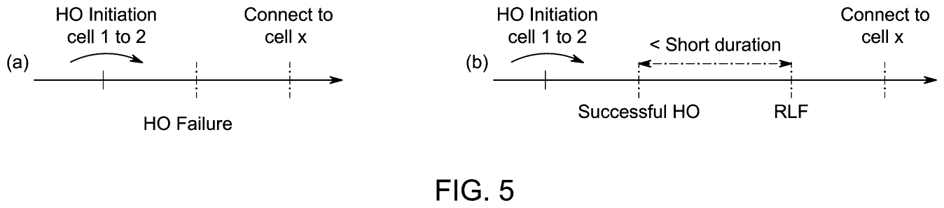

FIG. 5 illustrates examples of mobility problems that may occur when a handover is not appropriately controlled, according to an embodiment.

Referring to (a) of FIG. 5, the UE may initiate a handover from a cell 1 to a cell 2. In a case in which the handover attempt does not succeed, the UE may connect instead to another cell x. This example may correspond to a handover failure event.

Referring to (b) of FIG. 5, the UE may initiate a handover from a cell 1 to a cell 2, in which case the handover may be shown as being initially successful. However, after a short duration the link quality may deteriorate, causing the UE to experience an RLF. Following the RLF, the UE may connect to another cell x. This example may correspond to a scenario in which the handover was initiated too early or to an unsuitable target, ultimately leading to a failed connection.

In various embodiments disclosed herein, a UE may be configured to apply an AI/ML model to determine whether to initiate transmission of a measurement report or whether to trigger a handover. This approach may differ from network-centric procedures, in which the serving cell configures event-based triggers and may make handover decisions based on threshold comparisons. By enabling the UE to evaluate its own measurements through a trained AI/ML model, the handover process can be made more adaptive to user-specific mobility conditions while still permitting network handover intervention.

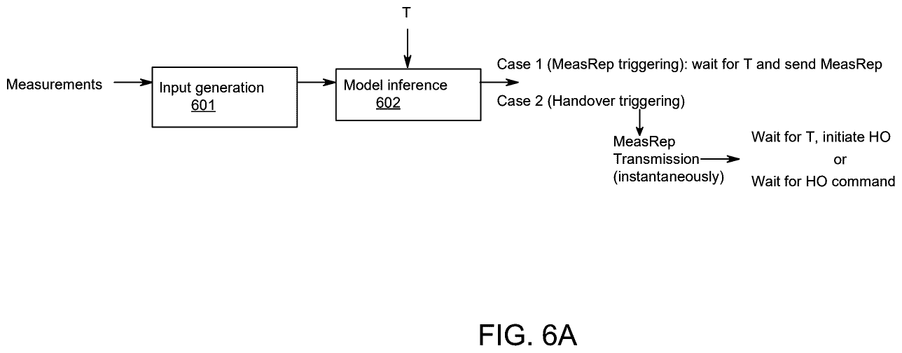

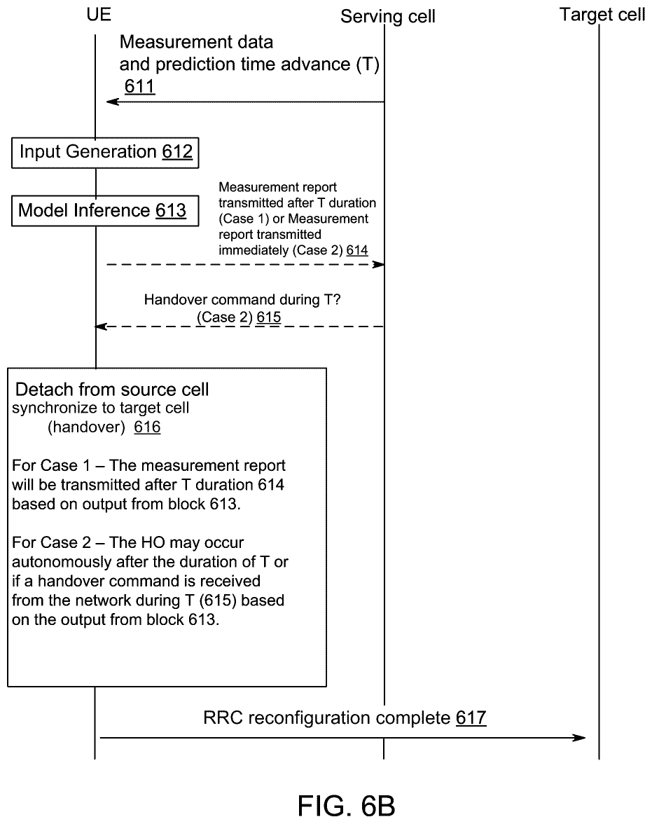

FIG. 6A is a block diagram illustrating an AI/ML-based framework for measurement reporting and handover triggering, according to an embodiment.

One or more of the blocks or steps shown in FIG. 6A may be performed on a UE, such as a smartphone, tablet, or other wireless terminal, executing instructions on its controller. In some embodiments, portions of FIG. 6A may be implemented at a gNB, for example where the network receives raw or pre-processed measurements from the UE and performs the inference centrally. The framework shown in FIG. 6A may also be distributed, with the UE generating inputs and the gNB performing inference, depending on system configuration.

Referring to FIG. 6A, measurements such as signal quality measurements associated with a serving cell and one or more candidate cells may be provided to an input generation component 601. In some embodiments, the measurements may include layer three (L3) quantities such as RSRP, RSRQ, or SINR. In other embodiments, additional measurements such as Doppler, layer one (L1) metrics, time, or location information may be included.

The input generation component 601 may construct input data for model inference. For example, at a current time N, the UE may segment a measurement log into a window of K measurement instances (e.g., K=15) distributed over a time grid (e.g., 120 ms spacing). Missing values may be interpolated using linear regression or extrapolated using zero-holding techniques. Each measurement vector may include values from both the serving cell and one or more candidate cells, and the K vectors may be concatenated in time order to form a feature vector. Various embodiments may vary the window size K, use non-uniform grids, include best candidate cells identified by criteria such as maximum RSRP, or use other interpolation or extrapolation techniques. In some embodiments, raw measurements with timestamps may be used directly as inference inputs.

An input vector output from the input generation component 601 may be supplied to a model inference component 602, which may apply an AI/ML model to determine whether to trigger a mobility procedure. In some embodiments, the AI/ML model may be implemented as a gradient boosting classifier trained in a supervised learning fashion. Training may involve sequentially fitting decision trees to residual errors, where predicted outputs may be subtracted from ground-truth labels corresponding to mobility outcomes such as successful handovers, frequent handovers, or RLFs. The final ensemble of trees may output a score that is mapped to a decision of whether to initiate a measurement report or a handover.

In other embodiments, the model inference component 602 may implement a neural network. For example, the neural network may include multiple fully connected layers followed by nonlinear activation functions, and may be trained to output a probability distribution over TTT label classes such as proper, low, or high. During operation, the input vector is propagated through the layers of the network, and the output probabilities are evaluated to determine whether a measurement report should be transmitted or a handover initiated.

The model inference component 602 may also incorporate a prediction time advance (T) as an additional input. The parameter T may define an interval between the moment when the AI/ML model predicts that an action should occur and the actual execution of the action. For example, if the model predicts that a handover should occur within the next T ms, the UE may transmit a measurement report immediately but defer the actual handover until the interval T has elapsed, unless a network command is received in the meantime. Based on the inputs, the inference component 602 may output a decision mapping to one of two operational cases (Case 1 and Case 2).

As shown in FIG. 6A, the output of the inference component 602 maps to two operational cases. In Case 1 (measurement reporting), the model output indicates that a measurement report (MeasRep) should be transmitted. In this case, the UE may wait for the duration T and then start transmission of a measurement report(s) including serving cell and one or more candidate cell measurements. The network may configure the granularity of the measurements included in the report depending on UE speed, cell size, or service requirements. In Case 2 (handover triggering), the UE may initiate transmission of a measurement report(s) (the network can also configure the UE not to send any measurement reports) identifying the candidate target cell and then waits for the duration T. If no network command is received during the interval, the UE may autonomously initiate a handover to the candidate cell. If the network transmits a handover command within T, the UE may execute the network-directed handover instead. However, if the network rejects the UE's candidate cell, the network may indicate to the UE not to perform the handover (this indication for example can be done through RRC signaling and may include an addition of a new dedicated field(s)). When multiple candidate cells are available, the UE may select a best candidate cell based on criteria such as signal strength, link quality, or cell load, or the network may override this selection with its own command.

In one embodiment, the inference component 603 may be implemented as a trained gradient boosting model, where predicted outputs are subtracted from label values across boosting stages. In another embodiment, the inference module may be a neural network trained to output probability distributions over label classes (e.g., perform handover, not perform handover, send measurement report, or do not send measurement report). Training data may be constructed by mapping mobility outcomes (e.g., successful connection, frequent handover, or radio link failure) recorded in network logs into corresponding labels (e.g., perform handover, not perform handover, send measurement report, or do not send measurement report).

Alternative embodiments may cause evaluation by the model inference component 602 to occur only when new target cell measurements are available, or may require persistence of a trigger condition across multiple inference steps. Additionally or alternatively, the model inference component evaluation may use both an AI/ML model and network event triggering conditions (for example taking AND, OR, or other logical operations, of an event triggering result and AI/ML model output to determine a mobility procedure (e.g., handover triggering or measurement report transmission)). An “event triggering result” may include an outcome of evaluating a configured legacy handover or measurement reporting event (such as event A1, A2, A3, etc., which may be defined by thresholds, hysteresis, and/or TTT conditions). In addition, there can be a default mobility procedure which can also be altered by the network through, for example, a dedicated RRC signaling.

FIG. 6B is a signaling diagram illustrating initiating an AI/ML-based measurement report and handover initiation, according to an embodiment.

One or more of the blocks or steps shown in FIG. 6B may be performed on a UE, such as a smartphone, tablet, or other wireless terminal, executing instructions on its controller. In some embodiments, portions of FIG. 6B may be implemented at a gNB, for example where the network receives raw or pre-processed measurements from the UE and performs the inference centrally. The framework shown in FIG. 6B may also be distributed, with the UE generating inputs and the gNB performing inference, depending on system configuration.

Referring to FIG. 6B, a UE obtains prediction time advance (T) and measurements of a serving cell and one or more candidate cells in accordance with configurations signaled by the network in step 611. The measurements may include L3 signal quantities such as RSRP, RSRQ, or SINR. In some embodiments, additional measurements such as Doppler frequency shift, L1 metrics, location, or timing information may also be used.

The measurements are provided to an AI/ML inference component at block 612 (corresponding to block 601 in FIG. 6A). Then, at block 613 (corresponding to block 602 in FIG. 6A), the input feature vector generated from a measurement history together with a prediction time advance (T) may be processed by a model inference component. The model inference component 613 may implement an AI/ML model such as a gradient boosting classifier or a neural network. In operation, the model inference component 613 may output a determination of whether the UE should transmit a measurement report or initiate a handover.

If the output corresponds to Case 1 (measurement reporting), the UE may start transmission of measurement report(s) in step 614 to the serving cell after waiting for the duration T. The measurement report may include both serving cell and one or more candidate cell measurements and may follow a configured reporting format or a default template. If the output corresponds to Case 2 (handover triggering), UE may start transmission of measurement report(s) right away in step 614 if the network does not transmit a handover command within the interval T in step 615, the UE autonomously may initiate a handover in block 616 to the candidate cell. If a handover command is received from the serving cell during T, instead the UE executes the network-directed handover in block 616. In scenarios with multiple candidate cells, the UE may select the best candidate cell based on network-configured criteria such as signal strength, link quality, or cell load (given by the network).

In some embodiments, the network may configure the UE to adjust the granularity of measurements and transmitted measurement reports depending on UE speed, mobility state, or cell size. In some embodiments, the network may request that the UE include additional information, such as all measurements taken during the interval T, their average, or another function of the measurement sequence.

As with the procedure in FIGS. 2-3, the UE detaches from the serving cell, synchronizes with the target cell, and completes RRC reconfiguration in step 617.

In some embodiments, the procedures of FIG. 6B may operate within the framework of event-triggered measurement reporting defined in 3GPP specifications. In other embodiments, the procedures may align with conditional handover, where the prediction time advance T is set to zero. In that case, the UE may execute the handover immediately upon satisfaction of the condition while still permitting network intervention.

Alternative embodiments may further refine the operation of FIG. 6B. For example, the inference output may be constrained to remain stable for multiple successive input vectors before triggering a measurement report or handover, reducing the likelihood of reacting to transient fluctuations. In another embodiment, inference evaluation may only occur when new candidate cell measurements are available, or after a minimum time has elapsed since the last triggered action.

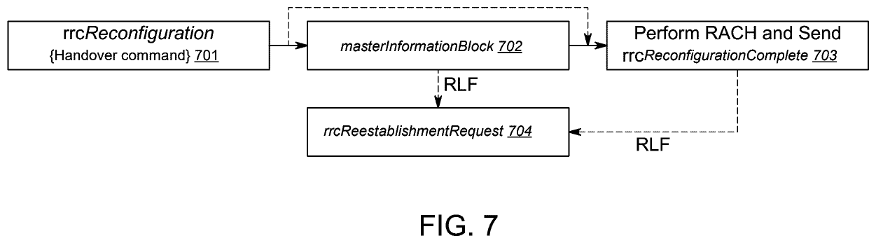

FIG. 7 is a signaling diagram illustrating a handover procedure, according to an embodiment.

One or more of the blocks shown in FIG. 7 may be performed on a UE, such as a smartphone, tablet, or other wireless terminal, executing instructions on its controller. In some embodiments, portions of FIG. 7 may be implemented at a gNB, for example where the network receives raw or pre-processed measurements from the UE and performs the inference centrally. The framework shown in FIG. 7 may also be distributed, with the UE generating inputs and the gNB performing inference, depending on system configuration.

Referring to FIG. 7, the UE may receive an RRC reconfiguration message 701 that includes a handover command from the serving cell. The RRC reconfiguration signaling may be used for a variety of radio link management tasks, and in the context of handover, it may include a reconfigurationWithSync command for the primary cell of the main cell group. In this case, the synchronization candidate cell may be set to a different cell than the current primary cell. Hereinafter, such an RRC reconfiguration message may be referred to as a handover command.

Following receipt of the HO command 701, the UE may acquire a master information block (MIB) 702 from the target cell to obtain system information needed for synchronization and random access channel (RACH) procedures. The HO-related MIB information may include, for example, the system frame number and synchronization signal block (SSB) index. In some cases, decoding of the MIB may not be strictly required, and the handover can proceed depending on other system configurations. If the synchronization and RACH procedures are completed successfully, the UE may transmit an RRC reconfiguration complete message 703 to the target cell, indicating that the handover has succeeded.

However, if an RLF occurs either immediately after receiving the MIB 702 or during the RACH and reconfiguration complete message 703, the UE may transmit an RRC re-establishment request 704 to attempt to recover connectivity. While connected to NR, the RRC re-establishment request 704 may provide a clear indication of RLF. If the UE instead reconnects to LTE, no such message may be transmitted, in which case the occurrence of an RLF can be inferred by checking for the absence of other signaling such as an RRCRelease or a MobilityFromNR command.

As shown in FIG. 7, premature or unstable handover initiation may result in repeated RLF events and re-establishment cycles, increasing service interruption and signaling overhead. By applying the inference-based framework described in FIGS. 6A-6B, the UE can reduce the likelihood of such scenarios by aligning measurement report transmission and handover initiation with a prediction time advance (T).

According to an embodiment, training an AI/ML model for user-centric handover control may use labeled data that reflects whether a handover was executed at the proper time. However, such user-centric data may not be natively available in a network, if the handover procedure is initiated and controlled by the serving cell. To address this limitation, a sample generation framework may be applied to derive labeled training samples from network-side logs of mobility events. These logs may include information such as measurement reports, handover commands, and RLFs. By converting these logs into structured training inputs and labels, supervised learning models can be trained to predict appropriate handover timing.

According to an embodiment, a sample generation procedure may be applied to construct labeled training data directly from field logs of mobility events. Accordingly, this approach may provide supervised training of AI/ML models even when user-centric labels are not explicitly available from the network. By deriving labels from observed network-side signaling and outcomes, the models may be trained to perform timely measurement report and handover triggering, thereby avoiding mobility issues such as frequent handover, too-late handover, and handover failure.

To construct training samples, the UE or a training system may first gather information from field logs, including both the signaling messages and their timing. The relevant information may include: i) triggered events, such as the event identifier, the measurement object used, the triggering time, and any configured parameters; ii) transmitted measurement reports, including their content and the time of transmission; iii) performed cell measurements, including L3 values and their sampling times; iv) observed handover commands, including the time of reception and the target cell; and v) observed RLFs, including the time of failure and the identity of the cell to which the UE reconnects after the failure. This information can provide the raw data for generating both input data and supervisory labels.

The input portion of each training sample may be generated from the performed cell measurements, following the procedures described in the input generation component of FIGS. 6A-6B. The labeling portion may then be derived from the timing of handover commands, measurement reports, and RLFs, in combination with a configured prediction time advance (T). For example, in the handover initiation scenario with T=0, the label may be set to “handover” (“HO”) if the observed handover was successful, or “no handover” (“No HO”) if the observed handover failed. If T is non-zero, the time reference for labeling may be adjusted by subtracting the value of T from the observed signaling time.

In the case of measurement report triggering (Case 1 in FIGS. 6A-6B), the UE may first identify a target cell. For successful handover, frequent HO, or HO failure cases, the target cell may be the one specified in the handover command. For too-late HO cases, the target cell may be the cell to which the UE reconnects after the RLF. Once the target is identified, a responsible event may be determined. In the presence of a handover command, the responsible event may be the one that was triggered by a measurement report including both serving and target cell measurements. If no handover command is present, the responsible event may be one where a report including those measurements was transmitted, or would have been transmitted had the event triggered. If no unique responsible event can be identified, the instance may be excluded from sample generation. In some embodiments, multiple events may be used, such as selecting all triggered events or choosing the latest triggered one.

For each responsible event, a reference time may be defined. When a handover command is present, the reference time may correspond to when the responsible event was triggered. When no handover command is present, as in too-late handover instances, the reference time may correspond to the responsible event trigger time, or if no such event exists, the time of the RLF. A label, (e.g., “MeasRep_Label”), may then be generated. A successful handover may be labeled “1” (send), frequent handover or handover failure may be labeled “0” (do not send), and too-late handover may again be labeled “1.” For each performed measurement while the UE remained connected to the serving cell, if the measurement time is consistent with the labeling condition relative to the reference time, a sample may be created consisting of the input measurement vector and the MeasRep_Label.

For handover triggering (Case 2), a similar approach may be applied, but instead of determining a responsible event, the procedure may directly define a reference time handover (“HO_RLF_Time”). If a handover command is present, this may be the time of reception of the handover command. If no handover command is present, this may be the time of the RLF. Labels for handover initiation may then be generated. A successful handover may be labeled “1”, frequent handover or handover failure may be labeled “0”, and too-late HO may be labeled “1.” For each measurement performed while connected to the serving cell, a sample may be generated if the measurement time is consistent with the labeling condition relative to HO_RLF_Time. Each sample may include the input measurement vector and the HO label. Accordingly, labeled training data may be derived from raw field logs.

In alternative embodiments, the time reference adjustment may account for non-zero values of T, measurement interpolation strategies may vary, and labeling rules may be extended to include additional mobility outcomes. For example, other types of mobility related issues such as unnecessary handover can be used to derive labels and may be included in the sample generation process.

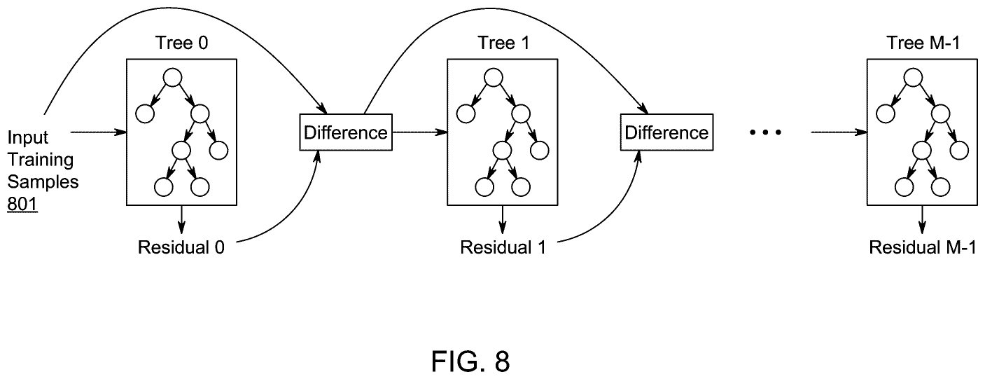

FIG. 8 is a schematic diagram illustrating a gradient boosting classifier for mobility prediction, according to an embodiment.

One or more of the functions described with reference to FIG. 8 may be performed on a UE, such as a smartphone, tablet, or other wireless terminal, executing instructions on its controller. In some embodiments, portions of FIG. 8 may be implemented at a gNB, for example where the network receives raw or pre-processed measurements from the UE and performs the inference centrally. The framework shown in FIG. 8 may also be distributed, with the UE generating inputs and the gNB performing inference, depending on system configuration.

Referring to FIG. 8, input training samples 801 may be formed by pairing measurement log sequences with candidate cell TTT values. Each training sample may therefore represent a potential handover decision point defined by a feature sequence O[K] and an associated TTT value. A series of decision trees (Tree 0, Tree 1, . . . , Tree M−1) may be trained in a boosting manner, where the output of each tree is subtracted from original label values to form residuals, and the next tree is trained on those residuals. This residual-learning process may be repeated for M boosting stages. After training, the outputs of the decision trees may be aggregated to form a final classification result (final_score), which predicts whether the candidate TTT value is proper, low, or high for the given input training sample, as shown in Equation 1, below.

$$final score = base score + \sum {Residual}_{m} \qquad Equation 1$$

In Equation 1, final score is the overall prediction of the model after M boosting stages (e.g., corresponding to proper TTT, low TTT, or high TTT), base score is the initial prediction prior to boosting, and Residualₘ is the residual error between the current model prediction and the corresponding label value at stage m summed over m=0 to M−1.

The categorical classes (labels) used in FIG. 8 may be derived from mobility outcomes observed in the network logs. For example, a measurement log sequence that results in a successful connection may be assigned a “proper” TTT label, whereas a sequence ending in an RLF may be assigned a “high” label, indicating that the TTT was too long. Similarly, a sequence associated with frequent handovers or an early handover failure may be assigned a “low” label, indicating that the TTT was too short. In this manner, raw mobility outcomes (e.g., successful connection, frequent handover, and/or RLF) may be systematically mapped into discrete TTT labels (proper, low, and/or high), which may then be used as ground truth for supervised learning. This relationship can be visualized by Table 1, below.

TABLE 1

| Instance | Successful HO | Frequent HO | Too late HO | HO Failure |
|---|---|---|---|---|
| TTT label | Proper | Low | High | Low |

Accordingly, the AI/ML model may be trained on user-centric data generated from network logs. Once trained, the gradient boosting model of FIG. 8 may be deployed at a UE to evaluate ongoing measurements and predict the appropriate TTT configuration in real time. In some embodiments, the boosting ensemble may be implemented using an XGBoost framework, which provides efficient handling of imbalanced datasets and regularization features to prevent overfitting.

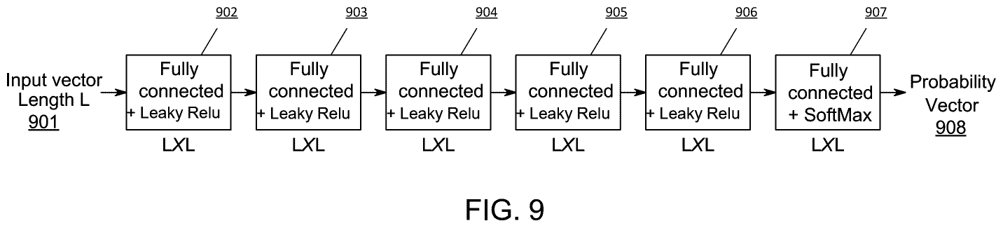

FIG. 9 is a schematic diagram illustrating a deep neural network model, according to an embodiment.

One or more of the functions described with reference to FIG. 9 may be performed on a UE, such as a smartphone, tablet, or other wireless terminal, executing instructions on its controller. In some embodiments, portions of FIG. 9 may be implemented at a gNB, for example where the network receives raw or pre-processed measurements from the UE and performs the inference centrally. The framework shown in FIG. 9 may also be distributed, with the UE generating inputs and the gNB performing inference, depending on system configuration.

Referring to FIG. 9, an input vector of length L 901 constructed from a measurement log sequence may be provided as input to a sequence of layers 902-906. Each layer 902-906 may apply nonlinear transformations through activation functions such as ReLU or sigmoid, enabling the model to capture complex relationships among features. The output of the final layer 907 may produce a probability vector 908 (distribution) over the candidate TTT labels based on a SoftMax function. For example, the probability vector 908 may output probabilities corresponding to proper, low, and high TTT outcomes, and the label with the highest probability may be selected as the predicted class. The neural network may be trained using a cross-entropy loss function, with stochastic gradient descent or adaptive optimizers such as Adam.

Accordingly, the diagrams illustrated in FIG. 8 and FIG. 9 illustrate approaches to implementing AI/ML-based mobility prediction. Gradient boosting (FIG. 8) may offer improved interpretability and faster training times on tabular data, while neural networks (FIG. 9) may provide greater flexibility for capturing nonlinear patterns across diverse datasets.

Once the training samples are constructed and labeled as described above, the AI/ML model may be trained to classify whether a given measurement log sequence and candidate TTT value correspond to a proper, low, or high label. In one embodiment, training samples may be formed as pairs of a measurement log sequence O[K] and a candidate TTT value. Each pair may be assigned a label based on observed mobility outcomes, where a successful handover may be mapped to a “proper” label, frequent or too-early handovers may be mapped to a “low label”, and too-late handovers leading to an RLF may be mapped to a “high” label. These labels may serve as ground-truth outcomes for supervised training.

A challenge in this process may be that the distribution of labels in real-world data may be highly imbalanced. For example, most handovers observed in the field may be successful and therefore labeled as “proper”, while relatively few cases may correspond to late handovers that result in RLF or frequent handovers indicative of low TTT values. To address this imbalance, according to an embodiment, weighting factors may be applied during training so that misclassification of minority labels incurs a higher penalty and therefore occurs with reduced frequency. According to another embodiment, oversampling of minority classes or undersampling of majority classes may be applied to balance the dataset. In some embodiments, data augmentation may be performed by interpolating between measurement sequences to generate additional synthetic samples for rare label types.

The frameworks described above may be extended to a variety of advanced mobility scenarios beyond single-cell handover in a network configuration.

In one embodiment, the techniques may be applied to dual connectivity, in which a UE maintains simultaneous links with a master cell group (MCG) and a secondary cell group (SCG). In such configurations, the UE may apply an AI/ML model to determine whether to initiate measurement reporting or to trigger cell group switching. For example, the UE may predict whether the SCG should remain active or be released based on current measurement trends and mobility outcome labels.

In another embodiment, the techniques may be applied to carrier aggregation (CA), where a UE aggregates multiple component carriers from one or more cells. The AI/ML model may be trained to decide whether additional component carriers should be activated or deactivated based on mobility outcomes observed in prior sessions. For instance, if activation of a secondary carrier frequently leads to unstable performance due to poor quality or frequent reconfiguration, the model may learn to delay or suppress such activations.

In another embodiment, the techniques may be extended to reinforcement learning (RL) approaches, in which the model does not rely solely on labeled samples derived from historical logs, but instead learns policies based on long-term performance rewards. For example, an RL agent may evaluate actions such as transmitting a measurement report, delaying a report, or initiating a handover, and may receive rewards based on connection stability, throughput, or reduced RLF events. Over time, the RL agent may converge on a policy that maximizes long-term service quality while minimizing unnecessary handovers.

Although gradient boosting and deep neural networks have been described herein, other machine learning models may also be employed. For example, random forests may provide ensemble-based classification with reduced sensitivity to noise, while logistic regression models may offer lower complexity implementations for resource-constrained devices. The choice of model may depend on deployment requirements such as computational capability, desired interpretability, and training dataset characteristics.

In another embodiment, similar concepts may be extended to mobility enhancements beyond handover, such as carrier aggregation (CA) and dual connectivity (DC). For example, the AI/ML framework may be trained to determine whether to activate, release, or switch a secondary cell (SCell) in a carrier aggregation scenario, or whether to perform a secondary cell group (SCG) switch in a dual connectivity scenario. In these cases, the model may evaluate measurements and prior mobility outcomes to decide whether secondary resources should be engaged, deferred, or suppressed, thereby improving stability and reducing unnecessary reconfigurations.

The techniques described herein may be implemented in a variety of device configurations, including UE and base stations such as gNBs. The AI/ML model for measurement report transmission and handover triggering may be executed entirely at the UE, entirely at the gNB, or in a split configuration where feature generation is performed by the UE and inference is executed by the gNB.

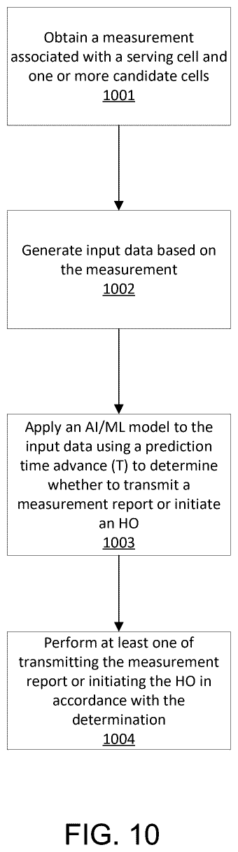

FIG. 10 is a flowchart illustrating a method performed by a UE for AI/ML-based measurement report transmission and/or handover initiation, according to an embodiment.

Referring to FIG. 10, in step 1001 the UE obtains a measurement associated with a serving cell and one or more candidate cells. These measurements may include signal strength or quality values such as RSRP, RSRQ, and SINR. For example, when the UE is connected to a serving cell but detects neighboring cells, the UE may record the corresponding RSRP, RSRQ, and SINR values for use in mobility decision-making.

In step 1002, the UE generates input data based on the measurement. The input data may be organized into a measurement log or formatted into a structured representation suitable for machine learning processing. For instance, the UE may collect a sequence of recent measurements of the serving and candidate cells and compile them into a feature vector representing time-series signal behavior.

In step 1003, the UE applies an AI/ML model to the input data using a prediction time advance (T) to determine whether to transmit a measurement report or initiate a handover from the serving cell to a target cell. The prediction time advance (T) may provide a look-ahead window so that the model evaluates whether a mobility action is expected to be needed within that duration. For example, if the model may predict that the serving cell signal will degrade below a threshold during the duration, the model may determine that a handover should be initiated. Conversely, if the serving cell signal remains adequate during the duration, the model may determine that a measurement report may be transmitted at that time.

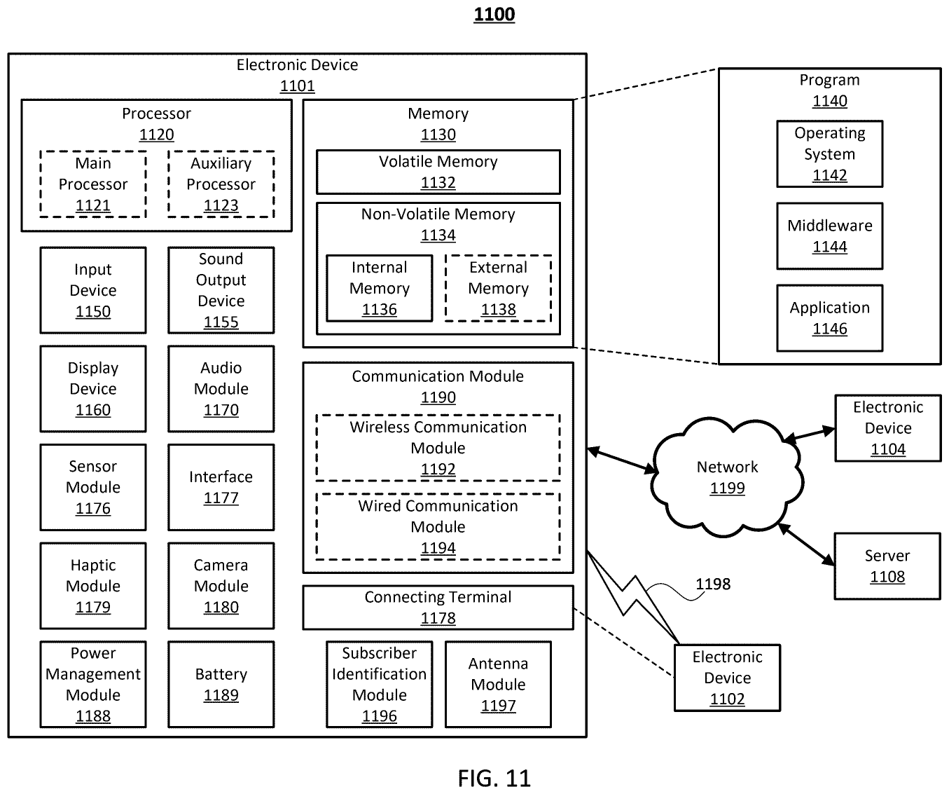

In step 1004, the UE, in accordance with the determination, performs at least one of transmitting the measurement report or initiating the handover. For example, if the model predicts that a handover will be initiated, the UE may initiate a handover to a target cell autonomously. Alternatively, if the model predicts that a measurement report will be transmitted, the UE may transmit a measurement report to the serving cell FIG. 11 is a block diagram of an electronic device in a network environment, according to an embodiment.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1197. In one embodiment, at least one (e.g., the display device 1160 or the camera module 1180) of the components may be omitted from the electronic device 1101, or one or more other components may be added to the electronic device 1101. Some of the components may be implemented as a single IC. For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations.

As at least part of the data processing or computations, the processor 1120 may load a command or data received from another component (e.g., the sensor module 1176 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134. Non-volatile memory 1134 may include internal memory 1136 and/or external memory 1138.

The program 1140 may be stored in the memory 1130 as software, and may include, for example, an operating system (OS) 1142, middleware 1144, or an application 1146.

In various embodiments, the AI/ML-based measurement reporting and handover triggering techniques described herein may be executed by the processor 1120 of the electronic device 1101. For example, the main processor 1121 or the auxiliary processor 1123 may implement input generation and inference components described herein. Measurement data collected by the communication module 1190 and antenna module 1197 may be stored in the memory 1130 and processed by AI/ML inference logic (e.g., the model inference component in FIGS. 6A-6B) to determine whether to transmit a measurement report or to initiate a handover. The same hardware platform may also store and execute the gradient boosting or neural network architectures described above, enabling the device 1101 to perform user-centric mobility control in real time.

In some embodiments, the electronic device 1101 may operate as a UE within the network environment 1100, applying the disclosed techniques to evaluate serving cell and one or more candidate cell measurements. In other embodiments, the electronic device 1101 may be implemented as a gNB or server 1108 within the network environment, where the processor 1120 executes AI/ML models on measurements reported by UEs. In either case, the disclosed methods may be embodied in software components stored in the memory 1130 and executed by the processor 1120, or alternatively may be accelerated by specialized hardware such as a GPU or communication processor functioning as the auxiliary processor 1123.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high-definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as BLUETOOTH™, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

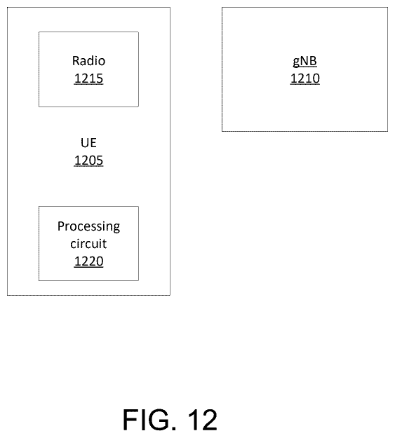

FIG. 12 is a system including a UE and a gNB, in communication with each other, according to an embodiment.

Referring to FIG. 12, The UE may include a radio 1215 and a processing circuit (or a means for processing) 1220, which may perform various methods disclosed herein, e.g., the method illustrated in FIG. 10. For example, the processing circuit 1220 may receive, via the radio 1215, transmissions from the network node gNB 1210, and the processing circuit 1220 may transmit, via the radio 1215, signals to the gNB 1210.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by user equipment (UE), the method comprising:
obtaining a measurement associated with a serving cell and one or more candidate cells;
generating input data based on the measurement;
applying an artificial intelligence or machine learning (AI/ML) model to the input data using a prediction time advance (T) to determine whether to transmit a measurement report or initiate a handover from the serving cell to a target cell; and
in accordance with the determination, performing at least one of transmitting the measurement report or initiating the handover.

2. The method of claim 1, wherein obtaining the measurement comprises determining at least one of a reference signal received power (RSRP), reference signal received quality (RSRQ), or signal-to-interference-plus-noise ratio (SINR) from a reference signal.

3. The method of claim 1, wherein generating the input data comprises segmenting a measurement log into a window of K measurement instances and forming time-ordered measurement values associated with the serving cell and the one or more candidate cells.

4. The method of claim 1, wherein obtaining the measurement associated with the serving cell and one or more candidate cells comprises obtaining at least one of a triggered event, transmitted measurement report, performed cell measurement, observed handover command, or observed radio link failure, and
wherein the AI/ML model is trained using the obtained measurement.

5. The method of claim 1, further comprising training the AI/ML model using labels derived from mobility outcomes recorded in network logs, the mobility outcomes comprising at least one of a successful connection, frequent handover, and radio link failure.

6. The method of claim 1, further comprising receiving, from a network node, a configuration that indicates the determination of whether to transmit the measurement report or initiate the handover is based on an output of the AI/ML model and an event triggering result.

7. The method of claim 1, wherein applying the AI/ML model to the input data further determines whether to trigger cell group switching, and in a case in which the determination indicates cell group switching, performing cell group switching.

8. The method of claim 1, further comprising, in response to determining that a handover will be transmitted then, within a time duration indicated by T, initiating the handover upon expiration of T.

9. The method of claim 1, further comprising receiving, from a network node, information indicating to abstain from transmitting the measurement report or information indicating to abstain from initiating the handover.

10. The method of claim 1, wherein applying the AI/ML model to the input data further determines whether to activate or deactivate one or more component carriers, and
in a case in which the determination indicates activating the one or more component carriers, performing activation of the one or more component carriers, and
in a case in which the determination indicates deactivating the one or more component carriers, performing deactivation of the one or more component carriers.

11. A user equipment (UE) comprising a processor and a memory storing instructions which, when executed by the processor, cause the UE to:
obtain a measurement associated with a serving cell and one or more candidate cells;
generate input data based on the measurement;
apply an artificial intelligence or machine learning (AI/ML) model to the input data using a prediction time advance (T) to determine whether to transmit a measurement report or initiate a handover from the serving cell to a target cell; and
in accordance with the determination, perform at least one of transmitting the measurement report or initiating the handover.

12. The UE of claim 11, wherein obtaining the measurement comprises determining at least one of a reference signal received power (RSRP), reference signal received quality (RSRQ), or signal-to-interference-plus-noise ratio (SINR) from a reference signal.

13. The UE of claim 11, wherein the processor is further configured to receive, from a network node, information indicating to abstain from transmitting the measurement report or information indicating to abstain from initiating the handover.

14. The UE of claim 11, wherein obtaining the measurement associated with the serving cell and one or more candidate cells comprises obtaining at least one of a triggered event, transmitted measurement report, performed cell measurement, observed handover command, or observed radio link failure, and
wherein the AI/ML model is trained using the obtained measurement.

15. The UE of claim 11, wherein the processor is further configured to train the AI/ML model using labels derived from mobility outcomes recorded in network logs, the mobility outcomes comprising at least one of a successful connection, frequent handover, and radio link failure.

16. The UE of claim 11, wherein the memory stores a configuration received from a network node, the configuration indicating the determination of whether to transmit the measurement report or initiate the handover is based on an output of the AI/ML model and an event triggering result.

17. The UE of claim 11, wherein applying the AI/ML model to the input data further determines whether to trigger cell group switching, and in a case in which the determination indicates cell group switching, performing cell group switching.

18. The UE of claim 11, wherein the processor is further configured, in response to determining that a handover will be transmitted then, within a time duration indicated by T, to initiate the handover upon expiration of T.

19. The UE of claim 11, wherein applying the AI/ML model to the input data further determines whether to activate or deactivate one or more component carriers, and
in a case in which the determination indicates activating the one or more component carriers, performing activation of the one or more component carriers, and
in a case in which the determination indicates deactivating the one or more component carriers, performing deactivation of the one or more component carriers.

20. A non-transitory computer-readable medium storing instructions which, when executed by one or more processors of a UE, cause the UE to:
obtain a measurement associated with a serving cell and one or more candidate cells;
generate input data based on the measurement;
apply an artificial intelligence or machine learning (AI/ML) model to the input data using a prediction time advance (T) to determine whether to transmit a measurement report or initiate a handover from the serving cell to a target cell; and
in accordance with the determination, perform at least one of transmitting the measurement report or initiating the handover.
